(19) United States
(12) Patent Application Publication
(10) Pub. No.: US 2008/0215715 A1
(43) Pub. Date: Sep. 4, 2008

(54) Recording medium storing information distribution program, information distribution apparatus, and information distribution method

(75) Inventors: Toshihiko Kurita, Kawasaki (JP); Takeshi Ohtani, Kawasaki (JP); Toshihiko Naritomi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/010,201

(22) Filed: Jan. 22, 2008

(30) Foreign Application Priority Data
Jan. 24, 2007 (JP) JP2007-13625

(51) Int. Cl. G06F 15/16

(52) U.S. Cl. 709/221

(57) ABSTRACT

Information may be distributed to a plurality of communication devices connected to a network by creating a distribution route including a plurality of levels by assigning a plurality of following level stations (0-level to n-level stations) to the distribution route, distributing information from one of the communication devices as an m-level station in a lower level to one of the communication devices as an (m+1)-level station in a level lower than the lower level in which the m-level station is present using the distribution route, monitoring a distribution status of the information distributed, and changing the distribution route based on the distribution status.

### BACKGROUND

1. Field

The present invention relates to a recording medium storing an information distribution program, an information distribution apparatus, and an information distribution method for creating a distribution route and distributing information when many communication devices distribute the information.

2. Description of the Related Art

Conventionally, an information distribution apparatus creates a hierarchical structure including each of communication devices, to which information is to be transmitted, as units of constituent elements based on the units and a number, and controls distribution of the information using the hierarchical structure as disclosed in, for example, Japanese Patent Application Laid-Open No. 2006-279810. With the control, the information distribution apparatus can reduce total distribution time for distributing information to a plurality of communication devices so as to efficiently distribute information.

FIG. 20 shows a configuration of the conventional information distribution apparatus.

The conventional information distribution apparatus makes a control apparatus determine a distribution route among communication devices depending on the number and installation locations of distribution destinations, i.e., the communication devices in advance, and sequentially distributes the distribution route (distributing order) and information to be distributed according to the determined distribution route. FIG. 20 shows a case that a 2×2 combination is determined as a combination for minimizing a value (number of distribution destinations at a level (x))×(number of distribution levels (y)) so as to make total distribution time shortest in relation to the distribution of information to six communication devices. The distribution route in a hierarchical structure are thereby created.

However, such a conventional information distribution apparatus is incapable of changing (or adjusting) the route created in advance after the distribution is started. Because of this, when the created route includes an unexpectedly delaying path or a failure occurs, the communication may be disadvantageously disrupted and slow down. And, the conventional information distribution apparatus does not have a monitor to confirm arrival of the information. Besides, the conventional information distribution apparatus controls information to be sent out to a next level, the control apparatus cannot confirm arrival of the information at all the communication devices. An embodiment of the present invention is intended to solve the conventional disadvantages.

### SUMMARY

According to an aspect of the present invention, there is provided a recording medium storing an information distribution program, the recording medium causing a computer transmitting information to a plurality of communication devices connected to a network to perform processing of:

(a) creating a distribution route including a plurality of levels by assigning a plurality of following level stations (0-level to n-level stations) at a distribution route creating means;

(b) distributing information using the distribution route created by the distribution route creating means at a distribution control means;

(c) monitoring a distribution status of the information distributed from one of communication devices as an m-level station in a lower level to one of the communication devices as an (m+1)-level station in a level lower than the lower level in which the m-level station is present at a distribution status monitoring means; and

(d) changing the distribution route created by the distribution route creating means, based on the distribution status monitored by the distribution status monitoring means, at a distribution route changing means.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a schematic view showing an example of an applicable field according to an embodiment of the present invention;

FIG. 2 is a block diagram showing an information distribution apparatus (i.e., a control apparatus);

FIG. 3 is a diagram showing a network configuration;

FIG. 4 is a table showing device properties of communication devices;

FIG. 5 is a table showing inter-device properties;

FIG. 6 is a flowchart showing a first example of creating a distribution route;

FIG. 7, part A and 7, part B are schematic diagrams showing structures of distribution routes;

FIG. 8 is a flowchart showing a second example of creating a distribution route;

FIG. 9 is a flowchart showing a third example of creating a distribution route;

FIG. 10 is a flowchart showing a fourth example of creating a distribution route;

FIG. 11, part A is a schematic view showing an initial distribution route in a second changing operation performed by a distribution route changing unit;

FIG. 11, part B is a schematic view showing a changed distribution route in the second changing operation performed by the distribution route changing unit;

FIG. 12 is a flowchart showing a first changing operation performed by the distribution route changing unit;

FIG. 13, part A shows an example of initial distribution route;

FIG. 13, part B shows an example of a changed distribution route;

FIG. 14 is a schematic view showing an example of the second changing operation for adding 2-level stations performed by the distribution route changing unit;

FIG. 15 is a flowchart showing the second changing operation performed by the distribution route changing unit;

FIG. 16, part A is a schematic view showing an initial distribution route in the second changing operation performed by the distribution route changing unit;

FIG. 16, part B is a schematic view showing a changed distribution route in the second changing operation performed by the distribution route changing unit;

FIG. 17 is a schematic view showing an operation for confirming arrival of distribution information;

FIG. 18 is a schematic view showing a thin client system;

FIG. 19 is a block diagram showing an example of a configuration of the thin client system; and

FIG. 20 is a schematic view showing an example of a conventional technique.

### DETAILED DESCRIPTION OF THE PREFERRED EMBODIMENTS

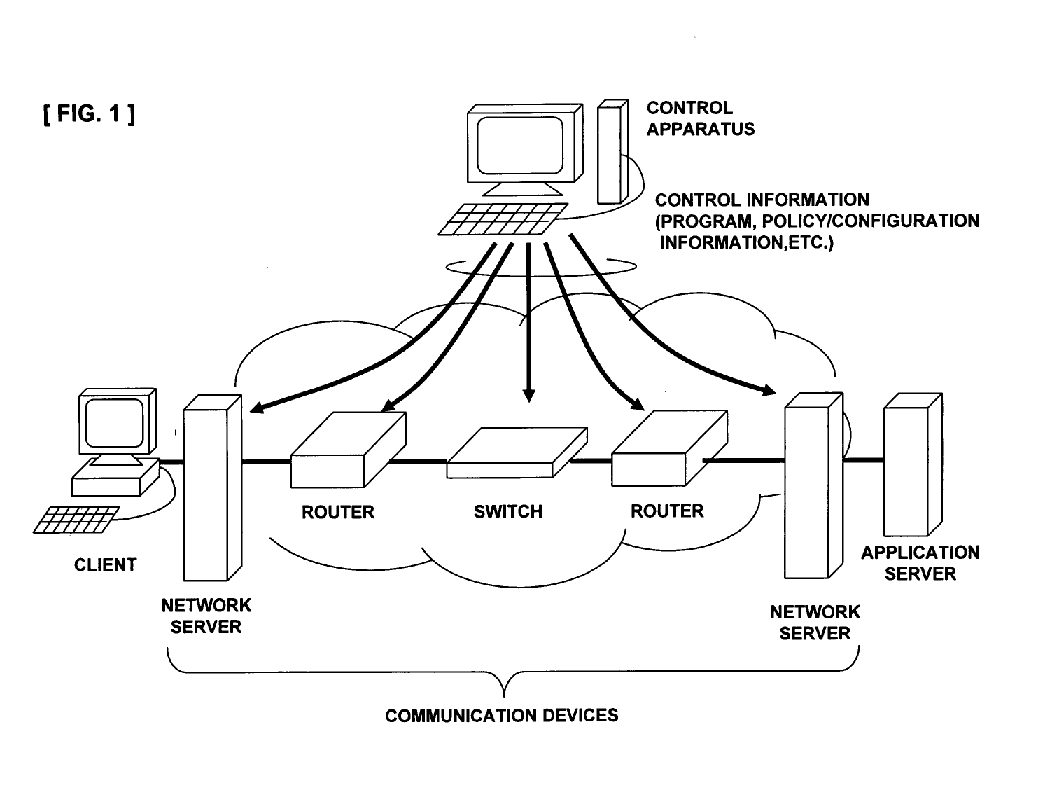

The embodiment of the present invention relates to an information distribution method for distributing information by providing a distribution route that can complete distribution in short time and so as to improve network utilization efficiency when a control apparatus serving as an information distribution apparatus distributes information to a plurality of communication devices connected to a network as shown in FIG. 1. In the embodiment, information to be distributed includes information common to all the communication devices such as recording medium storing a program or a patch and information slightly different between the communication devices such as policy/configuration information (i.e. common information+device-specific information).

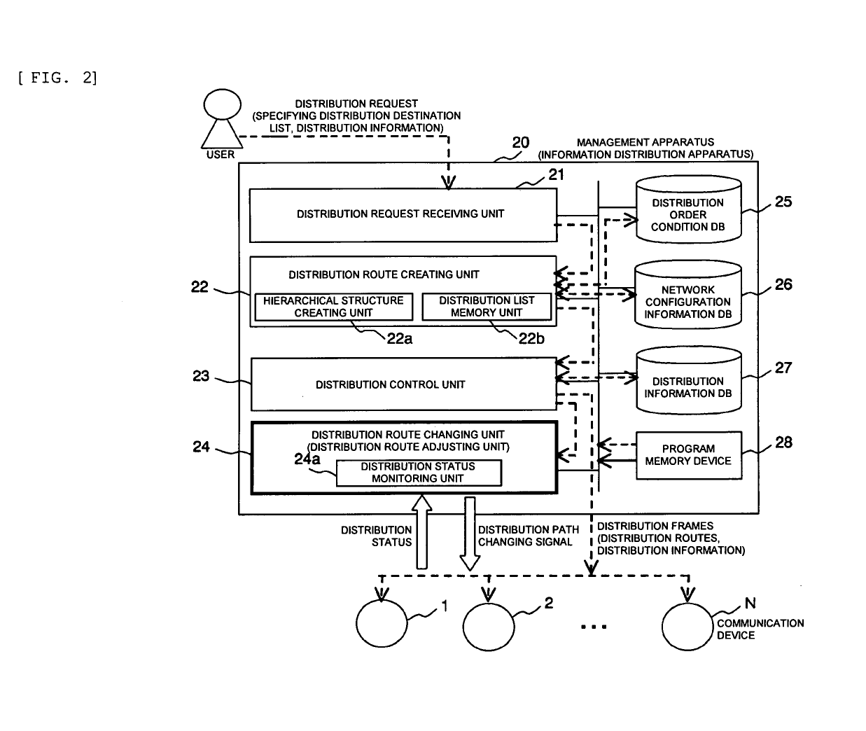

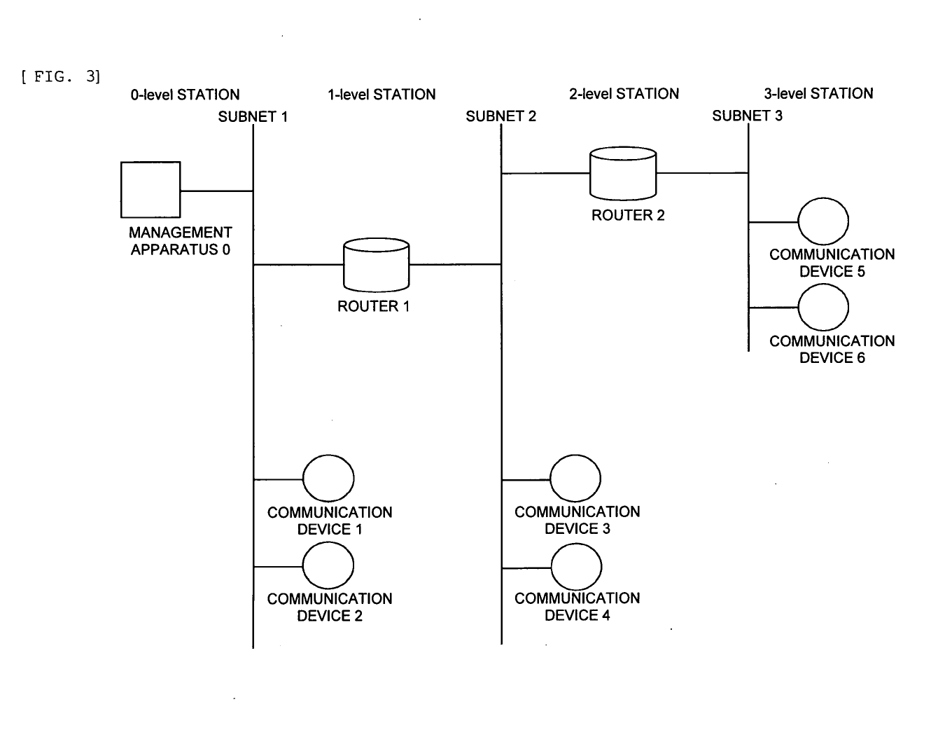

FIG. 1 is a schematic view showing an applicable field of the embodiment of the present invention. FIG. 2 is a functional block diagram showing a configuration of the information distribution apparatus according to the embodiment. FIG. 3 is a diagram showing an exemplary configuration of a network. As shown in FIG. 3, the information distribution apparatus may consist of a network device control apparatus (hereinafter, “control apparatus”) managing network devices (i.e., communication devices), each of which is connected to a network having a plurality of levels (subnet −1 to subnet −3) and constituting one of a plurality of levels of stations (0-level to n-level stations (three levels in the embodiment)).

This information delivery device (network equipment management device) works by using the data stored in various data bases.

Referring to FIG. 2, a network device control apparatus (information distribution apparatus) 20 includes a distribution request receiving unit 21, a distribution route creating unit 22, a distribution control unit 23, a distribution route changing unit (i.e., distribution route adjusting unit) 24, a distribution order condition database 25 storing therein a distribution order condition, a network configuration information database 26 storing therein network configuration information, a distribution information database 27 storing therein distribution information, recording-medium memory device 28 that records the program that executes the method of delivering information to the computer. The distribution route creating unit 22 includes a hierarchical structure creating unit 22a for making the communication devices correspond to the stations corresponding to the respective levels so as to creating a network route hierarchically.

The hierarchical structure creating unit 22a stores the created distribution route in a distribution list memory unit 22b and supplies the created distribution route to the distribution control unit 23. The distribution route changing unit 24 changes the distribution route stored in the distribution list memory unit 22b depending on distribution status as will be described later. The distribution route changing unit 24 includes a distribution status monitoring unit 24a for monitoring the distribution status (of the communication devices) on the distribution route.

The distribution request receiving unit 21 receives a user's distribution request (specifying a distribution destination list and distribution information) with a GUI (Graphical User Interface) or a CLI (Command Line Interface). The distribution route creating unit 22 creates and determines a distribution route among the communication devices (network devices) from 0-level to n-level stations. The hierarchical structure creating unit 22a creates a hierarchical structure for constructing a distribution route.

It is assumed herein that each of the communication devices 1 to N (each constituting one of the 0-level to n-level stations) means a communication device handled as a unit, and is constituted by a unit (with one input and one output) including one or more of communication devices.

The distribution control unit 23 controls actual distribution of the distribution information according to a distribution route determined by the distribution route creating unit 22. The distribution route changing unit 24 includes the distribution status monitoring unit 24a for monitoring the distribution status, and changes (or adjusts) the determined distribution route depending on the distribution status. The distribution order condition stored in the distribution order condition database 25 includes a condition for restricting a communication device setting order for the distribution information.

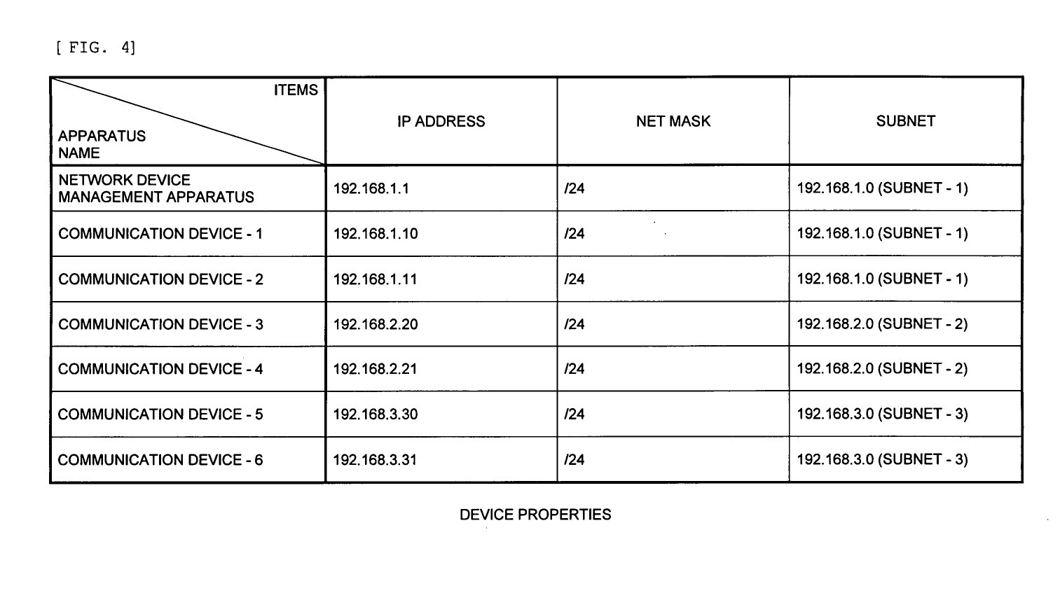

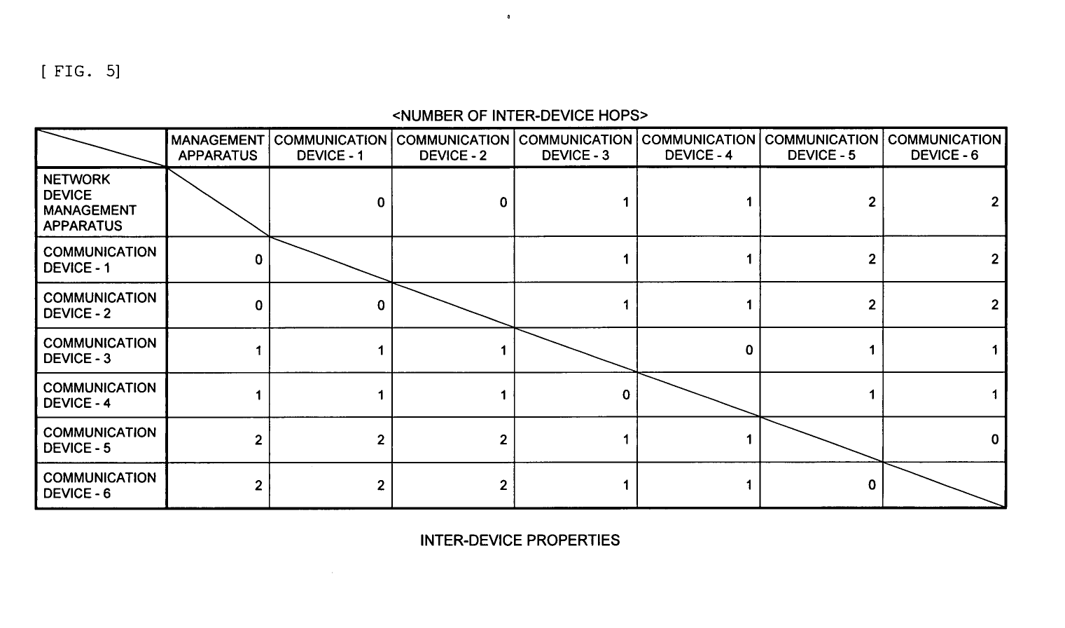

The network configuration information stored in the network configuration information database 26 includes device properties of the respective communication devices serving as destination destinations and inter-device properties (network properties). By way of example, a table shown in FIG. 4 is stored as the device properties of the communication devices 1 to 6 corresponding to the example of the configuration shown in FIG. 3, and a table shown in FIG. 5 is stored as the inter-device properties corresponding to the example of the configuration shown in FIG. 3.

Moreover, the distribution information stored in the distribution information database 27 includes control information (program and policy/configuration information) to be distributed to the communication devices.

With the above-stated configuration, when receiving a user's distribution request, the distribution request receiving unit 21 outputs the distribution request to the distribution route creating unit 22. The distribution route creating unit 22 creates (determines) a distribution route of the hierarchical structure while referring to the distribution order condition and the network configuration information stored in the respective databases 25 and 26, and outputs the distribution route to the distribution control unit 23. The distribution control unit 23 outputs a distribution frame including the distribution route and the distribution information to a nearest communication device specified in the distribution route. The distribution route changing unit 24 changes the distribution route depending on the distribution status while monitoring the distribution status of the communication devices of lower level.

In the embodiment, creating methods 1 to 4 of the distribution route operated by the distribution route creating unit 22 will be described first, and then changing methods 1 to 2 of the distribution route operated by the distribution route changing unit 24 to change (or adjust) the distribution route will be described next.

(First Method of Creating a Distribution Route)

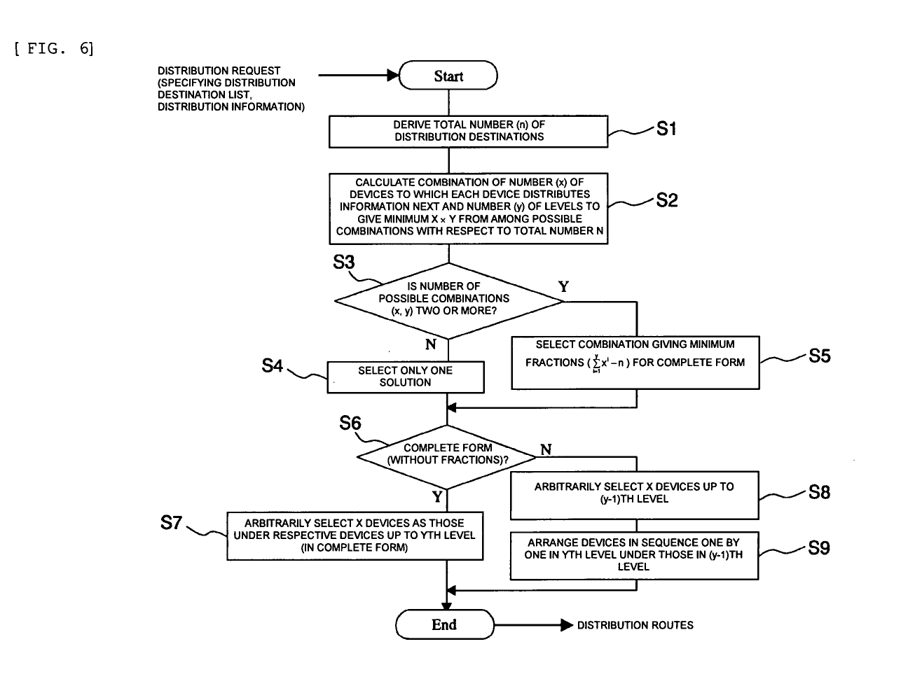

FIG. 6 is a flowchart showing the first method of determining a distribution route (creating a distribution structure) by the distribution route creating unit 22. It is to be noted that a distribution order is not considered.

When the distribution request receiving unit 21 receives the distribution request including the distribution destination list and specifying the designation information to be distributed, the distribution route creating unit 22 derives a total number (n) of the distribution destinations at the hierarchical structure creating unit 22a (step S1).

After the total number n is derived by the processing at the step S1, the distribution route creating unit 22 calculates a combination of x and y, where x is a number of communication devices (hereinafter, referred to simply as “devices”) to which each of the devices distributes the information next and y is a number of levels, so as to give a minimum solution (xxy) from among possible combinations thereof with respect to the derived total number n (step S2).

If the number of combinations that give the minimum solution (xxy) is one (N in step S3), the distribution route creating unit 22 selects the only one solution (step S4). If the number of combinations that give the minimum solution (xxy) is two or more (Y in step S3), the distribution route creating unit 22 selects a combination which gives minimum fractions for a complete form (step S5).

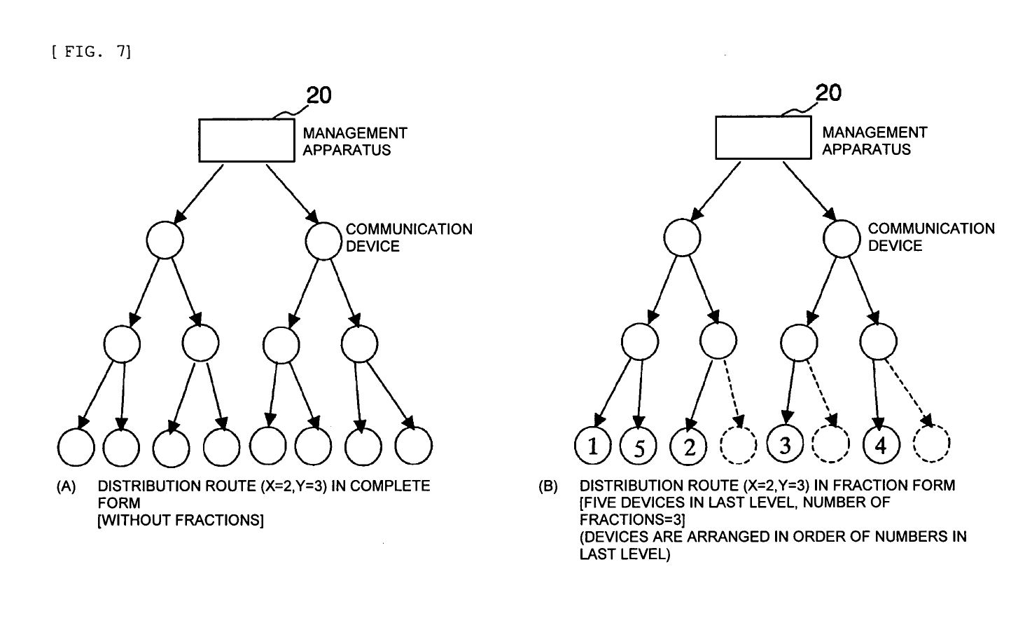

Here, the “complete form” means a form in which x devices in the last level (y^{th} level) are connected to all the devices in the previous ((y−1)^{th}) level (without fractions) as shown in FIG. 7A.

On the other hand, a “fraction form” means a form in which the x devices in the last level are not connected to all the devices in the previous level (with fractions) as shown in FIG. 7B. The devices in the last level in the fraction form are assumed to be arranged one by one sequentially under the devices in the previous level. The number of fractions of the fraction form is represented by the following expression.
Σxi-n, where i is an integer from 1 to y.

In this case, the number n satisfies the following condition.
Σxi (i=1 to y−1)≦Σxi (i=1 to y−1)

If the number of combinations having the same number of fractions is two or more at the step S5, the distribution route creating unit 22 selects a combination having a greatest x. This is intended to give a priority to device capabilities.

To arrange the devices after derivation of x and y, if the form is the complete form (Y in step S6), x devices are arbitrarily selected as those under the respective devices up to the y^{th} level (step S7). If the form is the fraction form (N in S6), then x devices are arbitrarily selected as those under the respective devices up to the (y−1)^{th} level (S8), and devices are arranged in sequence one by one in the y^{th} level, under each of those in the (y−1)^{th} level (step S9).

(Second Method of Creating a Distribution Route)

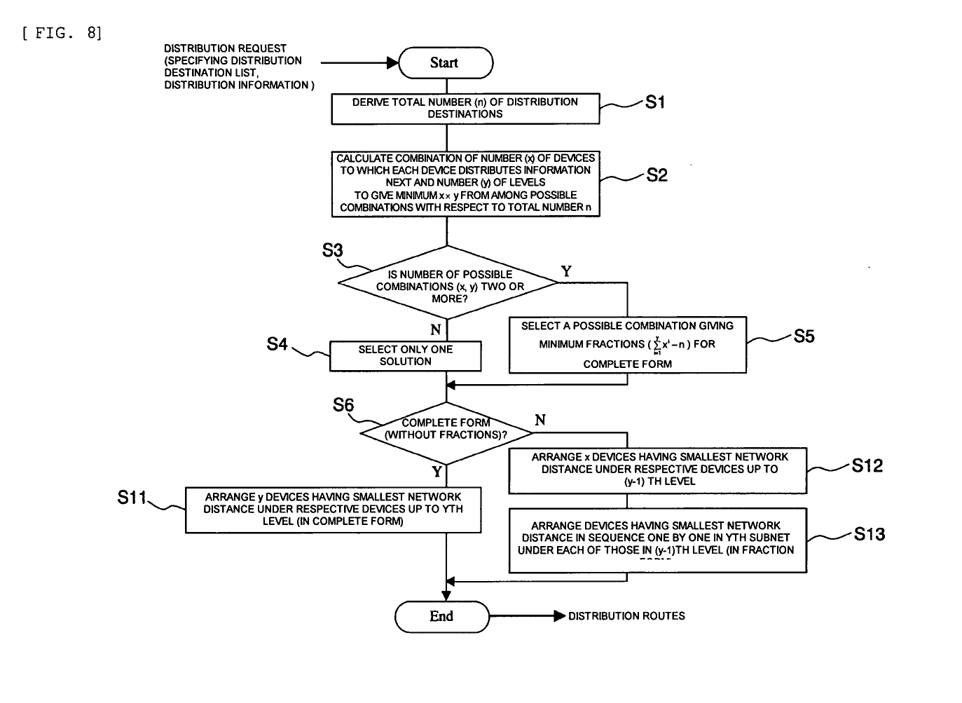

FIG. 8 is a flowchart showing the second method of determining a route (creating the distribution structure) by the distribution route creating unit 22. Here, the distribution order is not considered. In FIG. 8, steps until the derivation of x and y (Steps S1 to S6) are the same as those shown in FIG. 6 (First method of creating the distribution route).

To arrange the devices after the derivation of x and y, if the form is the complete form (Y in step S6), x devices having a smallest network distance are arranged under the respective devices up to the y^{th} level (step S11). If the form is the fraction form (N in step S6), then x devices having the smallest network distance are arranged under the respective devices up to the (y−1)^{th} level (step S12), and devices having the smallest network distance are arranged in sequence one by one in the y^{th} level, under each of those in the (y−1)^{th} level (step S13).

(Third Method of Creating a Distribution Route)

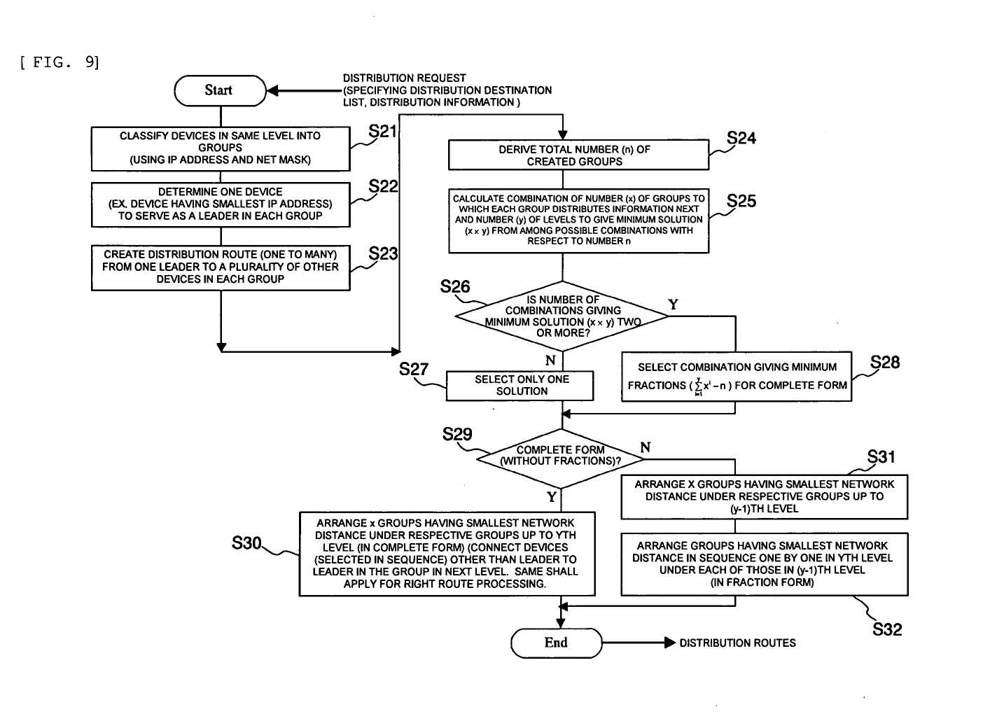

FIG. 9 is a flowchart showing the third method of determining a route (creating the distribution structure) by the distribution route creating unit 22. Similarly to the methods above, a distribution order is not considered.

When receiving a user's distribution request, the distribution route creating unit 22 firstly classifies the devices to be distribution destinations of the same level into groups according (step S21). In this case, the distribution route creating unit 22 determines whether or not each device is included in each group using an IP address and a net mask.

After performing the grouping, the distribution route creating unit 22 determines one device to serve as a Leader in each of the groups (S22). Specifically, the distribution route creating unit 22 determines, for example, the device having a smallest IP address as the Leader in each group. After Leaders are determined, the distribution route creating unit 22 creates a distribution route (one to many) from one Leader to a plurality of other devices in each group (step S23).

By performing the above-stated processing, the distribution route creating unit 22 derives the total number n of created groups (step S24).

The distribution route creating unit 22 calculates a combination of x and y, where x is a number of groups to which each of the groups distributes the information next and y is a number of levels, so as to give a minimum solution (xxy) from among possible combinations thereof with respect to the derived number n (step S25). The processing may be performed by sequentially checking all the combinations.

If the number of combinations that give the minimum solution (xxy) is one (N in step S26), the distribution route creating unit 22 selects the only one solution (step S27). If the number of combinations that give the minimum solution (xxy) is two or more (Y in step S26), the distribution route creating unit 22 selects a combination which gives minimum fractions for the complete form (step S28).

If the number of combinations having the same number of fractions is two or more at the step S28, the distribution route creating unit 22 selects a combination having a greatest x.

The procedure of deriving x and y described here corresponds to a procedure in which the communication devices (to be arranged) (one example of unit of communication devices) described with reference to FIG. 2 are replaced with groups each including a plurality of communication devices (another example of units of communication devices).

To arrange the devices after derivation of x and y, if the form is the complete form (Y in step S29), x groups having the smallest network distance are arranged under the respective groups up to the y^{th} level (step S30). In this time, the devices other than the Leader (selected in sequence) are connected to a Leader in the group at the next level. The same procedure shall apply to steps S31 and S32 to be described later.

If the form is the fraction form (N in step S29), then x groups having the smallest network distance are arranged under the respective groups up to the (y−1)^{th} level (step S31), and groups having the smallest network distance are arranged in sequence one by one in the y^{th} level, under each of those in the (y−1)^{th} level (step S32). The arrangement procedure at these steps corresponds to a procedure in which the devices to be arranged in FIG. 8 are replaced by groups.

(Fourth Method of Creating a Distribution Route)

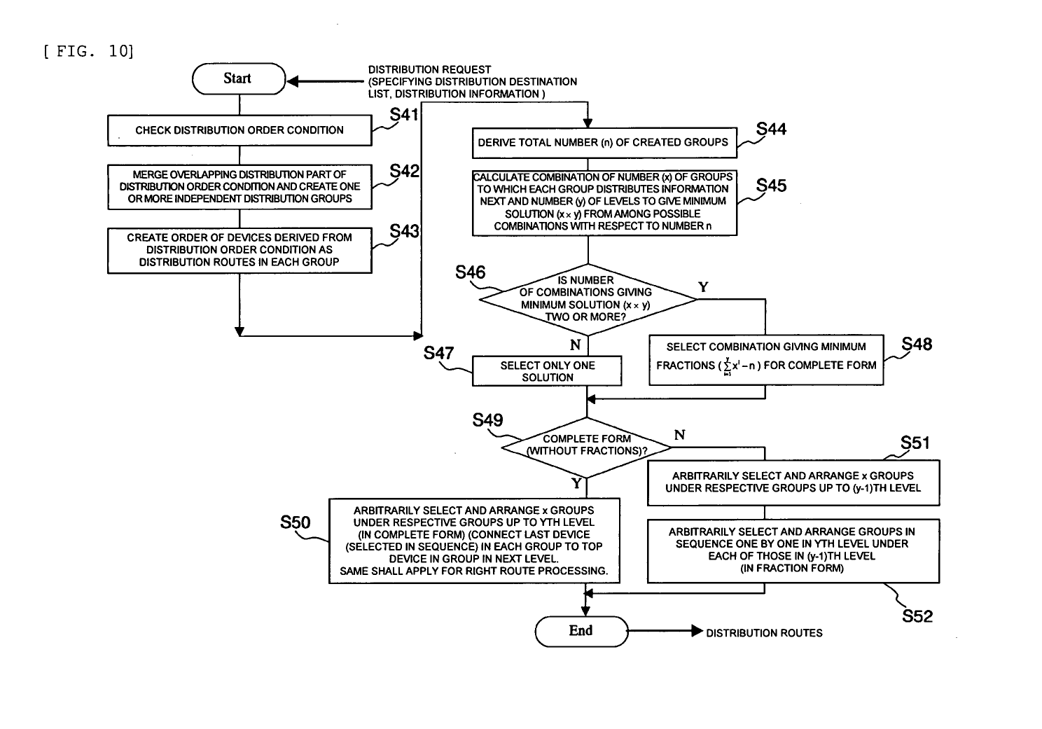

FIG. 10 is a flowchart showing the fourth method of determining a route (creating the distribution structure) by the distribution route creating unit 22. In the fourth method, a distribution order is considered.

When receiving a user's distribution request, the distribution route creating unit 22 firstly checks the distribution order conditions (step S41). The distribution route creating unit 22 then merges overlapping part of distribution order conditions and creates one or more independent distribution groups (step S42). Next, the distribution route creating unit 22 creates an order of the devices derived from the distribution order condition as a distribution route in each group (step S43). Thereby, the total number n of groups are derived (step S44).

Next, the distribution route creating unit 22 calculates a combination of x and y, where x is a number of groups to which each of the groups distributes the information next and y is a number of levels, so as to give a minimum solution (xxy) from among possible combinations thereof with respect to the derived number n (step S45). This processing is performed by sequentially checking all the combinations.

If the number of combinations that give the minimum solution (xxy) is one (N in step S46), the distribution route creating unit 22 selects the only one solution (step S47).

If the number of combinations that give the minimum solution (xxy) is two or more (Y in step S46), the distribution route creating unit 22 selects a combination which gives minimum fractions for the complete form (step S48). If the number of combinations having the same number of fractions is two or more at the step S48, the distribution route creating unit 22 selects a combination having a greatest x. The procedure of deriving x and y at these steps corresponds to a procedure in which the communication devices to be arranged and described with reference to FIG. 2 are replaced with groups.

To arrange the devices after derivation of x and y, if the form is the complete form (Y in step S49), x groups are arbitrarily selected as those arranged under the respective groups up to the y^{th} level (step S50). In this time, the last device in each group (selected in sequence) is connected to the top device in a group of the next level. The same procedure shall apply to steps S51 and S52 to be described later.

If the form is the fraction form (N in step S49), then x groups are arbitrarily selected as those arranged under the respective groups up to the (y−1)^{th} level (step S51), and groups are arranged in sequence one by one in sequence in the y^{th} level, under each of those in the (y−1)^{th} level (step S52). The arrangement procedure in these steps corresponds to a procedure shown in FIG. 2 in which the devices to be arranged are replaced with groups.

After the distribution route creating unit 22 creates the distribution route as stated above, the created list is temporarily memorized in the distribution list memory unit 22b.

(First Method of Changing a Distribution Route in a Distribution Route Changing Unit)

The distribution route changing unit 24 changes the distribution route created by the distribution route creating unit 22 in a case in which the created route includes an unexpectedly delaying path, a case of occurrence of a failure, or the like when the distribution control unit 23 distributes the information according to the distribution route, thereby preventing the communication from delaying and the distribution of the information from slowing down.

The distribution status monitoring unit 24a of the distribution route changing unit 24 monitors the distribution status of the communication devices under the control apparatus and changes a distribution route having a long distribution delay (a list of the communication devices to which the information is to be distributed next (distribution list)). The changing operation for a set of three levels is recursively repeated, for example. In this case, the distribution status monitoring unit 24a is preferably capable of changing distribution route shown in FIG. 2 not only for the communication devices in the lowest level but also for those in other levels.

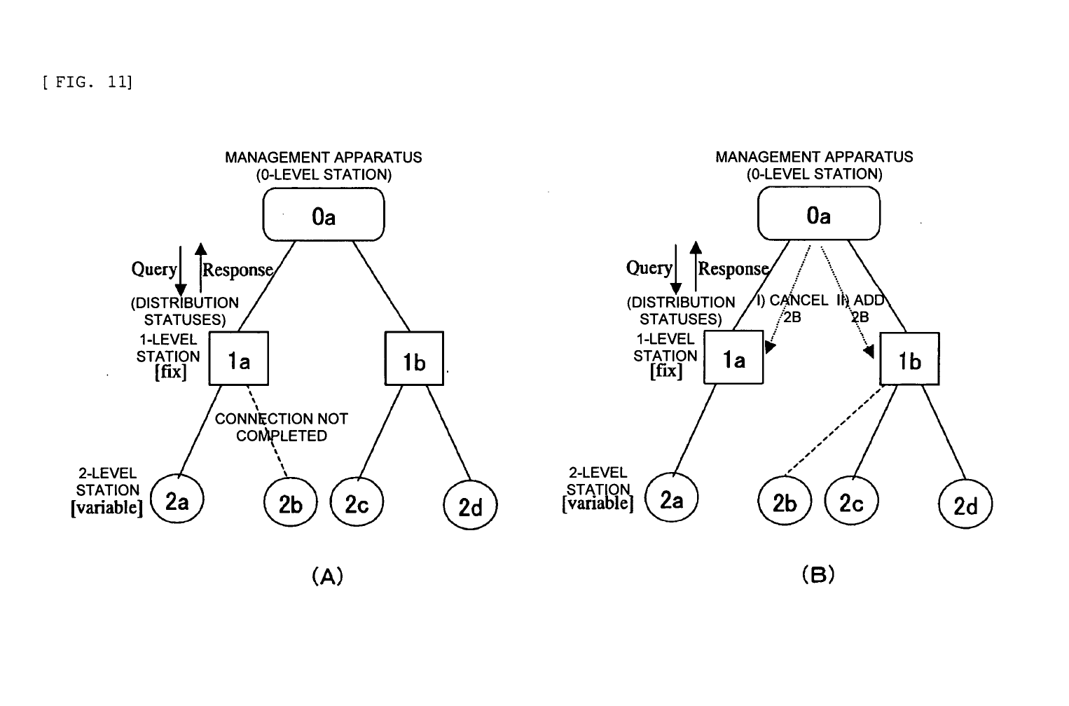

FIGS. 11A and 11B are schematic views showing distribution routes. FIG. 11A shows a distribution route according to the distribution list before changing the distribution route. The distribution route constitutes of three levels from the 0-level to the 2-level stations. The distribution status monitoring unit 24a in the 0-level station monitors the communication statuses of the communication devices (1a and 1b) in the 1-level stations by detecting queries for and responses from the communication devices (1a and 1b).

If the distribution status monitoring unit 24a determines that a long delay (a delay equal to or longer than predetermined time) occurs in the 2-level station (2b) shown in FIG. 11A because of non-completed connection, for example, the distribution route changing unit 24 changes the distribution route so as to switch the connection of the communication device 2b to a 1-level station from 1a to 1b. Route changing processes will be described.

<Example of Route Changing Process> (First Process)

A first process is an process for processing performed by the distribution status monitoring unit 24a to redistribute based on a ratio of communication speed (bps).

For example, 1-level stations (1a, 1b) measure speeds (bps) for distributing to 2-level devices (2a, 2b, 2c, 2d). The distribution status monitoring unit 24a probes (or notifies from 1-level station side) the communication speeds of the devices 1a and 1b in the 1-level station and the number of remaining devises (the number of devices to which information is not yet distributed) periodically (e.g., once in 30 seconds).

The distribution status monitoring unit 24a calculates an optimum distribution number of the remaining devices so as to match a speed ratio between 1-level stations. The distribution status monitoring unit 24a instructs a 1-level station, for which the calculated value does not match the actual number of remaining devices, to change connection to 2-level stations.

(Second Process)

A second process is an process for processing performed by the distribution status monitoring unit 24a to redistribute based on a ratio of processing speed, i.e. a number of devices processed per second.

For example, the distribution status monitoring unit 24a calculates the ratio of the numbers of devices processed, i.e. information is distributed from a 1-level station to a 2-level station, per second instead of the communication speed (bps) in the changing method described above and redistribute the remaining devices based on the ratio.

(Third Process)

A third process is an process in which the distribution status monitoring unit 24a define a device of an extremely low speed in 1-level, and if there exists a device satisfying the definition, the distribution status monitoring unit 24a changes the communication route only for the communication device using the first or second process.

For example, the distribution status monitoring unit 24a calculates an average speed (bps) (av) and a standard deviation (σ) of the communication devices in 1-level the control apparatus. The distribution status monitoring unit 24a defines stations of speed equal to or lower than (av-2σ) as stations of extremely low speed and then changes connection to 2-level stations only for the stations of extremely low speed based on the speed ratio with respect to (av).

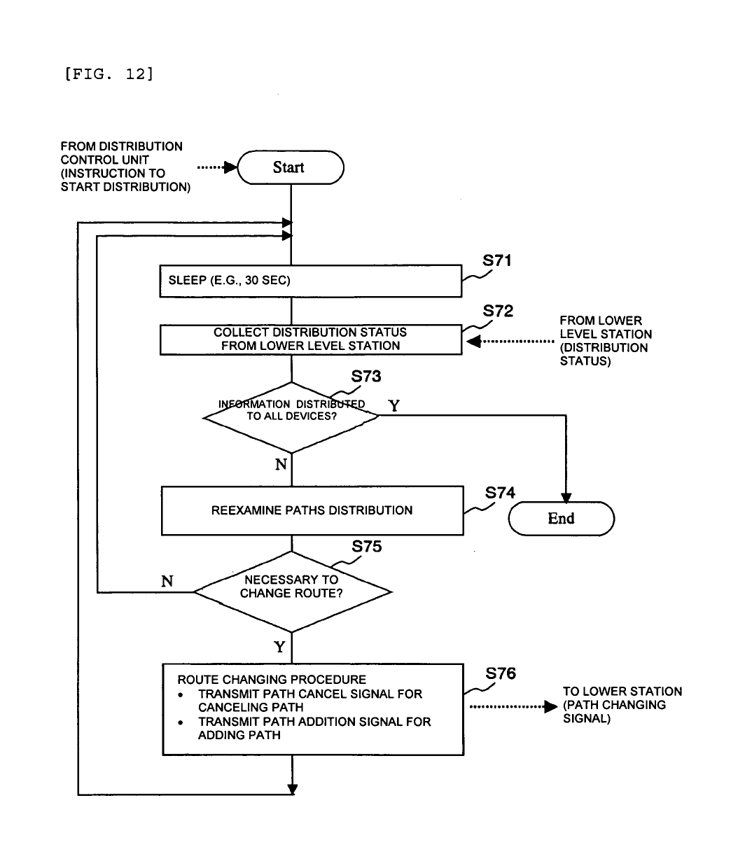

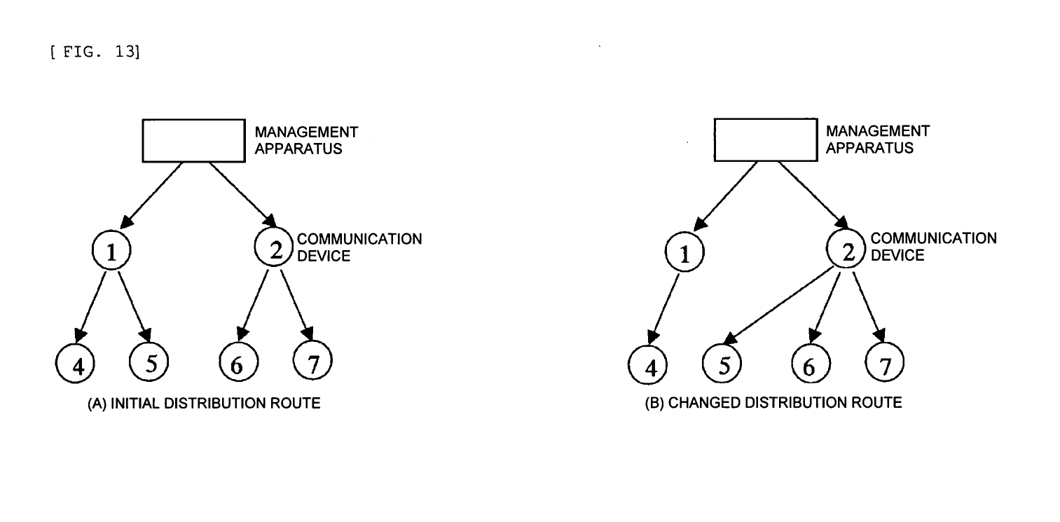

FIG. 12 is a flowchart showing an example of the operation performed by the distribution route changing unit 24. FIG. 13 is a schematic view showing a distribution route correcting method executed by the distribution route changing unit 24 as a result of the operation shown in FIG. 12.

In the flowchart of FIG. 12, when a distribution starts, the distribution route changing unit 24 receives an instruction to start distributing the information from the distribution control unit 23, and then starts functioning. First, the distribution route changing unit 24 sleeps for predetermined time (e.g., 30 seconds) (step S71), and collects distribution status from the stations in a following level (step S72). By defining individual distribution status messages (requests and responses), the distribution route changing unit 24 collects the following information from all of the stations in the following level.

(Number of Processed Devices, Number of Assigned Devices, [List of Identifiers in Remaining Route])

As another method of collecting the distribution status, a method using SNMP or the like as an existing protocol can be applied.

It is assumed that if the distribution route changing unit 24 sets distribution routes shown in FIG. 13A as an initial route before starting distribution and the control apparatus (information distribution apparatus), set as 0-level station, obtains the following information from devices 1 and 2 as 1-level stations.

1: (0, 2, [4, 5])

2: (1, 2, [7])

The former information indicates, for example, that “the number of processed devices by the device 1 is 0, the number of assigned devices to the device 1 is 2, and remaining route from the communication device 1 is for distributing information to devices 4 and 5”. This result shows that the device 1 has not completed the distribution. Therefore, the distribution route changing unit 24 performs a processing for reexamining of paths distribution (N in step S73; and step S74). A ratio of devices processed between the device 1 and the device 2 is 0:1, and a ratio of remaining devices is 2:1.

Assuming that a rule “route setting is to be corrected so as to make a difference in numbers of devices to be distributed from the two devices as small as possible” is stored in advance and the route is changed referring to the rule, two paths are to be assigned for the device 1 and one path is to be assigned for the device 2. Accordingly, it is necessary to change assignment of one path from the device 1 to the device 2 (Y in step S75).

Thus, the distribution route changing unit 24 performs the route changing processing (step S76). The distribution route changing unit 24 changes the route to the device 5 from the route via the device 1 to a route via the device 2. To perform the changing processing, the control apparatus transmits a path cancel signal, for canceling the path to the communication device 5, to the device 1 and transmits a path addition signal, for adding a path to the device 5, to the device 2. The route corrected as described above is shown in FIG. 13B.

The distribution status changing unit 24 performs the procedures stated thus far at regular intervals (corresponding to sleep time). When the remaining number finally becomes zero, the distribution route changing unit 24 determines that distribution is completed and finishes the processing.

(Second Method of Changing a Distribution Route in a Distribution Route Changing Unit)

In the first method of changing a distribution route, the distribution route creating unit 22 creates the distribution route list for all the devices and the distribution route changing unit 24 performs the processing for changing the created distribution route when needed. In a second route changing method, by contrast, all distribution paths (a list of all devices to which the information is to be distributed) are not assigned at the beginning but the distribution route changing unit 24 sequentially assigns remaining destinations according to status while the distribution status monitoring unit 24a monitors progress status of distribution in stations under the control apparatus.

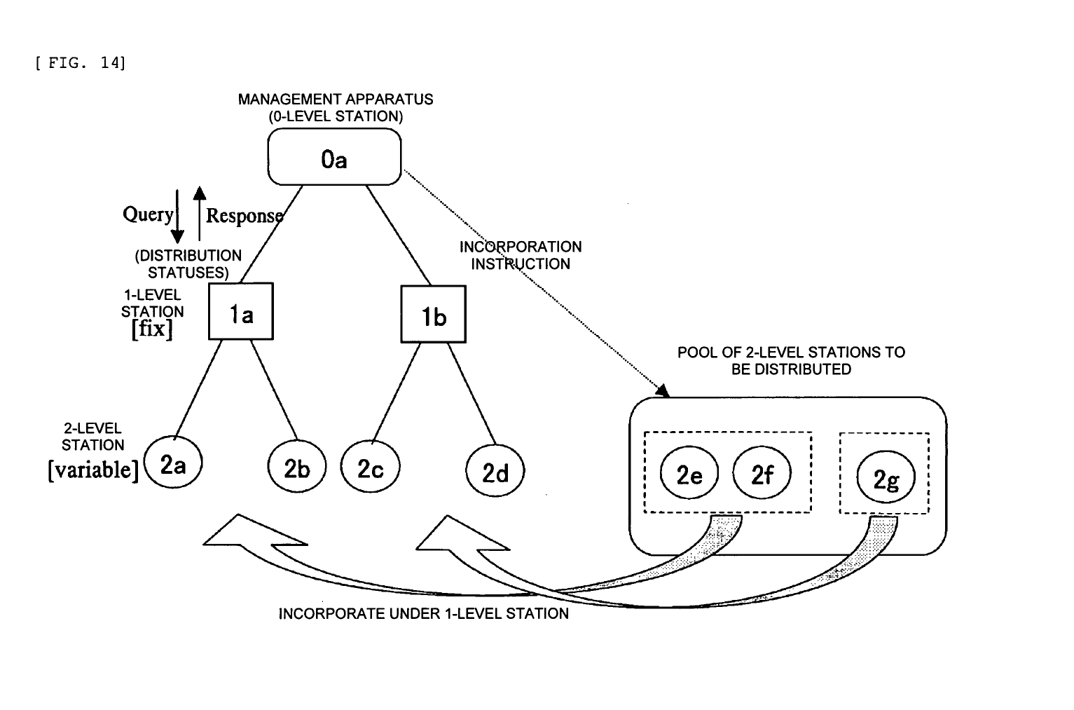

FIG. 14 is a schematic view of the second route changing method. A distribution route shown in FIG. 14 is a distribution route according to the distribution list before changing the distribution route. The distribution route shown in FIG. 14 is constituted by three levels from the 0-level to the 2-level stations. However, as for the 2-level stations, a distribution list is created only for a part of the devices. The distribution route changing unit 24 incorporates remaining communication devices into the distribution list as 2-level stations while monitoring distribution status.

The distribution status monitoring unit 24a in the 0-level station monitors the communication status of 1-level stations (1a and 1b) by detecting queries for and responses from the devices 1a and 1b. The distribution status monitoring unit 24a in the 0-level station incorporates a 2-level station to be added from a pool (paths not yet distributed) by connecting to one of the devices 1a and 1b depending on communication status. FIG. 14 shows an example with communication devices 2e, 2f and 2g as 2-level stations constituting paths not yet distributed and the distribution route is changed by adding devices by connecting devices 2e and 2f to the 1-level station 1a and a device 2g to the 1-level station 1b. This changing process will be described.

<Example of Route Changing Processes>

(First Process)

In a first process, the devices are redistributed based on a ratio of the communication speeds (bps).

First, the distribution route creating unit 22 calculates routes tentatively in advance, stores candidates for a list, actually incorporates a predetermined amount (e.g., 20%) of the candidates (i.e., the communication devices as the 2-level stations constituting the route) into the distribution route, and stores the remaining candidates in the pool.

The control apparatus in the 1-level station measures communication speeds (bps) to the 2-level stations. The distribution route changing unit 24 probe (or notifies) the communication speeds of the 1-level stations and the remaining number of devices at regular intervals (e.g., intervals of 30 seconds) in the distribution status monitoring unit 24a.

The distribution route changing unit 24 calculates an optimum distribution number of remaining devices so as to match the speed ratio of 1-level stations and incorporates a predetermined amount (e.g., 20%) of the devices in the pool into actual distribution routes so that the number of devices assigned to the 1-level stations ((remaining number)+(number of added devices from the pool)) match to a calculated ratio.

(Second Process)

A second process is a processing performed by the distribution route changing unit 24 to redistribute the devices based on a ratio of the number of devices processed per second.

The distribution route changing unit 24 calculates the ratio of the number of devices processed per second, for the process of distributing information to 2-level station by 1-level station, instead of communication speed (bps) and redistributes the remaining devices based on the calculated ratio.

(Third Process)

A third process is a processing performed by the distribution route changing unit 24 to distribute the devices cyclically.

Namely, the distribution route changing unit 24 cyclically distributes 2-level stations to stations in the next level of the control apparatus (1-level stations) one by one, and from the second cycle, assigns 2-level station starting from the 1-level station, which is earliest to finish the information transfer.

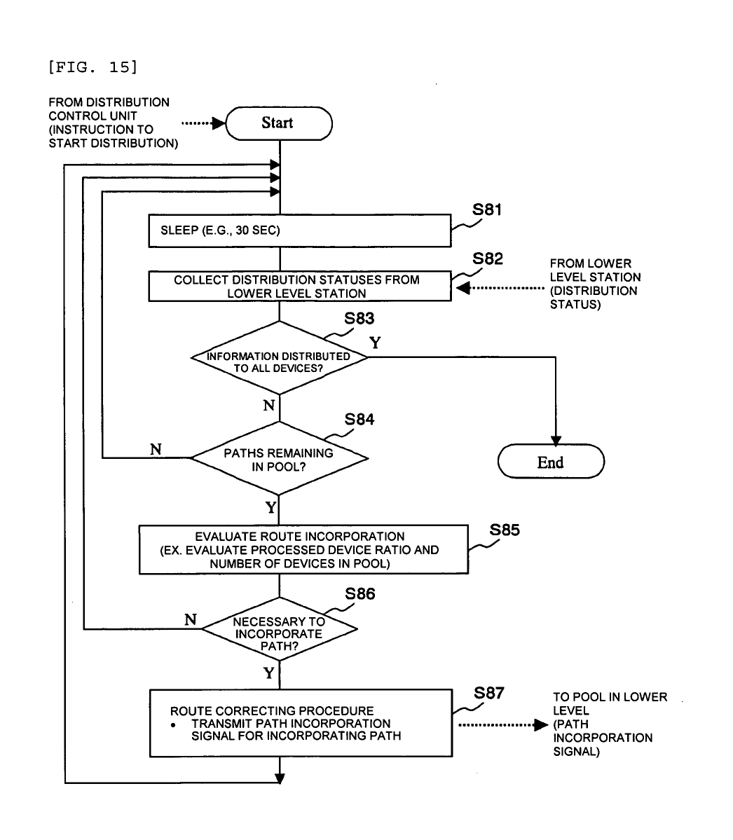

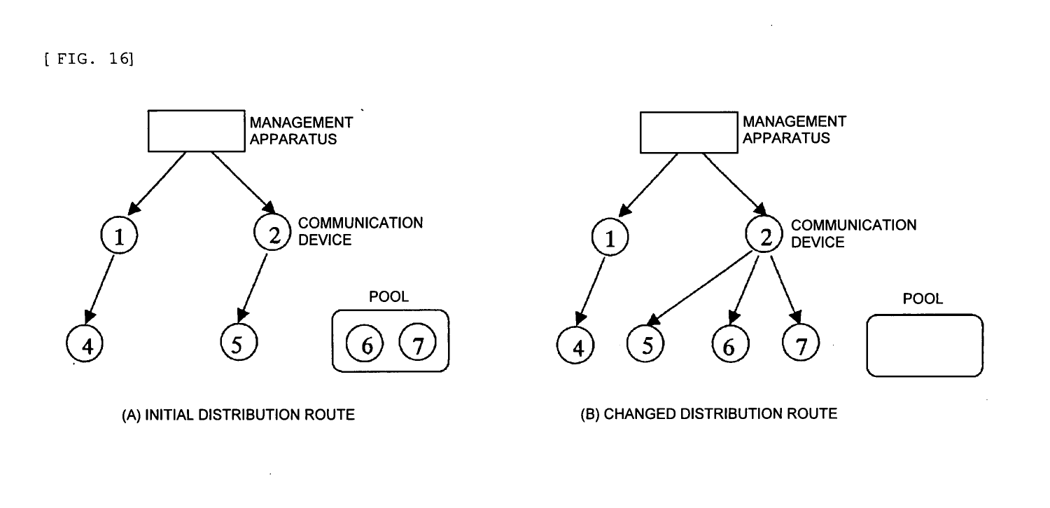

FIG. 15 is a flowchart showing an example of operation for executing the second distribution route changing method. FIG. 16 is a schematic view showing a distribution route correcting method.

In the flowchart of FIG. 15, when distribution start, the distribution route changing unit 24 receives an instruction to start distributing the information from the distribution control unit 23, and thereby starts functioning. First, the distribution route changing unit 24 sleeps for predetermined time (e.g., 30 seconds) (step S81), and collects distribution status from the stations in a following level (step S82). By defining individual distribution status messages (requests and responses), the distribution route changing unit 24 collects the following information from all of the stations in the following level.

(Number of Processed Devices and Number of Assigned Devices)

As another method of collecting the distribution status, a method using SNMP or the like as an existing protocol can be applied.

It is assumed that if the distribution route changing unit 24 sets distribution routes shown in FIG. 16A as an initial route before starting distribution and the control apparatus (information distribution apparatus), set as 0-level station, obtains the following information from the devices 1 and 2 as 1-level stations.

1: (0, 1)

2: (1, 1)

The former information indicates, for example, that “the number of processed devices by the device 1 is 0 and the number of assigned devices to the device 1 is 1”. The distribution route changing unit 24 determines that the device 1 has not completed the distribution based on the result indicated by such information and checking the pool (N in step S83). Therefore, the distribution route changing unit 24 determines whether remaining paths are present in the pool (step S84). In this embodiment, the distribution route changing unit 24 determines that paths to devices 6 and 7 remain in the pool (Y in step S84).

The distribution route changing unit 24 evaluates path incorporation (step S85). In this case, the processed device ratio between the device 1 and the device 2 as 1-level stations is 0:1. Assuming the rule of incorporating paths from the pool is “to assign paths twice as many as the number of processed device to each of the devices”, the distribution route changing unit 24 determines that zero path is to be assigned to the communication device 1 and two paths are to be assigned to the communication device 2 (step S86).

Accordingly, the distribution route changing unit 24 performs a route correcting procedure (step S87). As a result of these processing, the distribution route changing unit 24 adds the paths to the devices 6 and 7 to route via the communication device 2 from the pool. As a result of this addition processing, the control apparatus transmits a path incorporation signal for incorporating the path to the device 5 and that to the device 6 to the communication device 2. The routes corrected by the distribution route changing unit 24 as stated above are shown in FIG. 16B.

The distribution route changing unit 24 performs the procedures stated thus far at regular intervals (corresponding to sleep time). When the remaining number finally becomes zero, the distribution route changing unit 24 determines that distribution is completed and finishes the processing.

(Handling Procedure at Time of Occurrence of Failure Node)

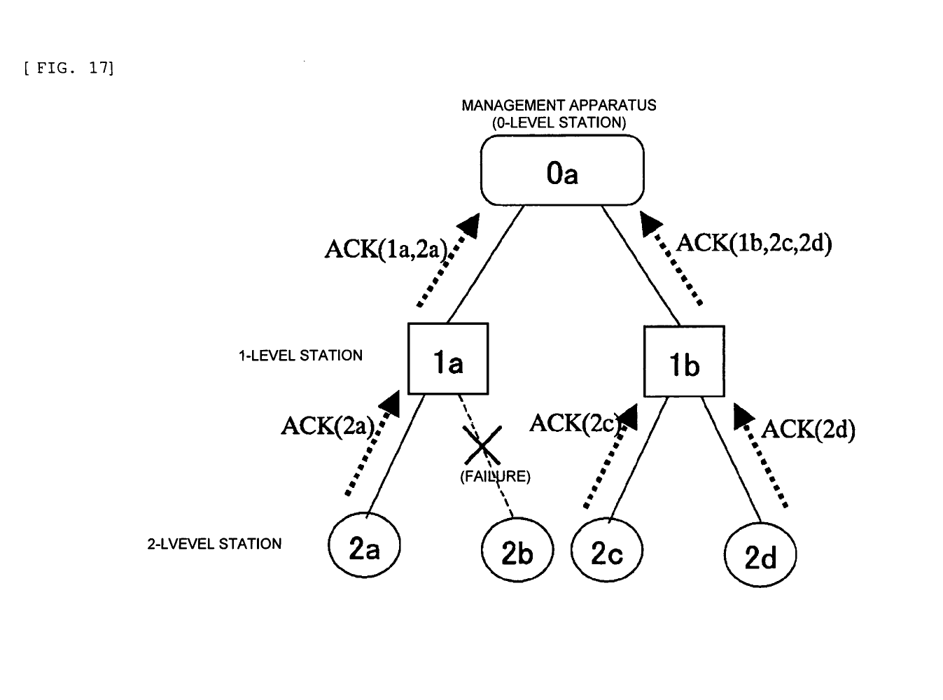

A processing for handling a failure node when the distribution status monitoring unit 24a detects the failure node will be described with reference to FIG. 17.

1) The Control Apparatus (Higher Station) Redistributes the Information.

As a first step, a 1-level station 1a detects a communication failure with a 2-level station 2a under the 1-level station 1a. To detect the communication failure, the 1-level station 1a performs “detection of ACK+timeout” in an application layer with respect to the 2-level stations, and ACK is transmitted to the control apparatus (information distribution apparatus (distribution status monitoring unit 24a)) through opposite route to the distribution route. All the ACKs are transmitted and received not in a TCP layer of ordinary TCP/IP communication but in the application layer.

As a second step, the 1-level station 1a transmits a notification to the control apparatus 0a. As a third step, the control apparatus 0a checks whether the control apparatus 0a can communicate with the 2-level station 2a. As a fourth step, if the control apparatus 0a can communication with the 2-level station 2a, the control apparatus 0a directly distributes the information to the 2-level station 2a. The distribution of the information by the control apparatus 0a is performed by the distribution control unit 23. Alternatively, the distribution route changing unit 24 may perform the distribution. As a fifth step, if the control apparatus 0a cannot communicate with the 2-level station 2a, the control apparatus 0a stops distribution, records the status in an error list, and takes such measures as making a CE call.

2) Another 1-Level Station (Another Station in the Same Subnet) Redistributes the Information.

In the example 1), the control apparatus that is the 0-level station directly distributes the information to the 2-level station 2a. Alternatively, another station in the same subnet as the 1-level station may distribute the information.

As a first step, a 1-level station 1a detects a communication failure with a 2-level station 2a under the 1-level station 1a. The detection by the device 1a is performed by, for example, detecting ACKs and timeout as stated above.

As a second step, the 1-level station 1a transmits a notification to the control apparatus 0a. As a third step, the control apparatus 0a requests another 1-level station (e.g., a 1-level station 1b although the control apparatus 0a can actually request a plurality of 1-level stations) to check whether the 1-level station can communicate with the 2-level station 2a. As a fourth step, if there is a 1-level station (i.e., 1-level station 1b in FIG. 17) which can communicate with the device, the control apparatus 0a requests the information distribution to the 2-level station. If none of the 1-level stations can communicate with the 1-level station 2a, then the control apparatus 0a stops distribution, records the status in the error list, and takes such measures as making a CE call.

In this manner, the system according to the embodiment can change the distribution route depending on the distribution status after the distribution when the above-stated failure node is found, and also enables the control apparatus to confirm whether the distribution information arrives at all the devices. Therefore, if the control apparatus founds a delaying distribution path or a failure path halfway along the distribution, the distribution route can be changed to avoid such a route. Moreover, the control apparatus can take measures (such as distribution of the information via another route) for avoiding the route via the station at which the control apparatus is incapable of confirming whether the information arrives.

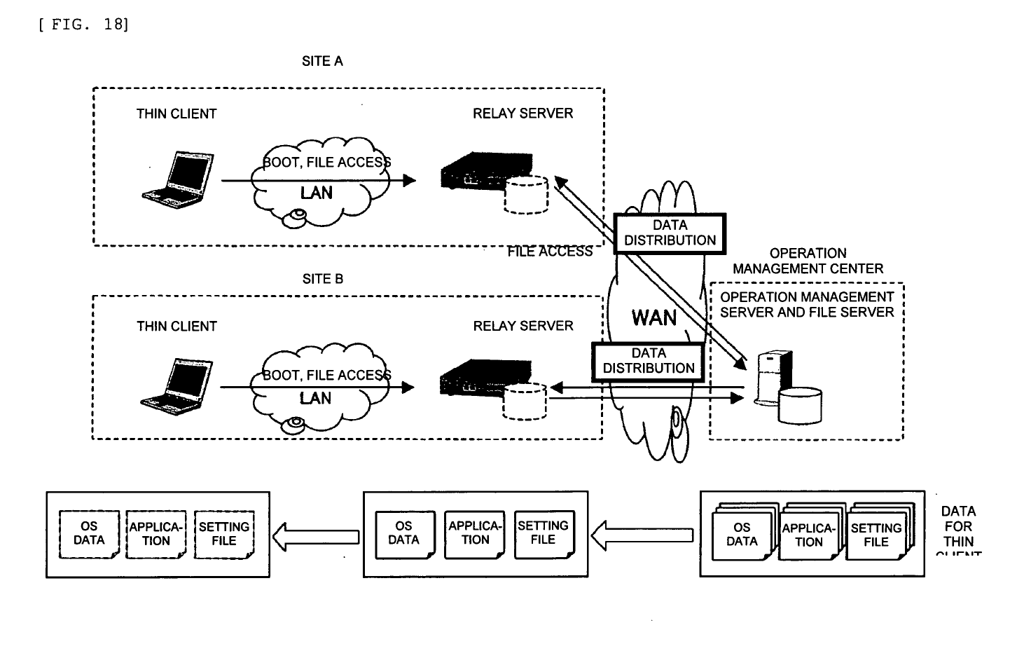

The embodiment of the present invention is also applicable to a thin client system. In a thin client system shown in FIG. 18, a central operation control server distributes OS/application to relay servers in advance, and each thin client acquires the OS/application from the relay servers and starts operating. The thin client system has the following requirements.

(1) The operation control server needs to distribute data to a great number of relay serves (in order of several hundreds to several tens of thousands). (2) Communication speed of network and server capabilities are not uniform. (3) Effective communication speeds of these networks and effective processing capabilities of the servers temporally change. (4) The other special requirements include scheduling distribution, association with data activation, continuation of distribution processing at the time of occurrence of a failure or switching, and the like. To meet these requirements, it is preferable to apply the embodiments of the present invention so as to improve data distribution efficiency when the operation control server distributes data to many relay servers (because the system malfunctions if the operation control server distributes data to the servers one by one).

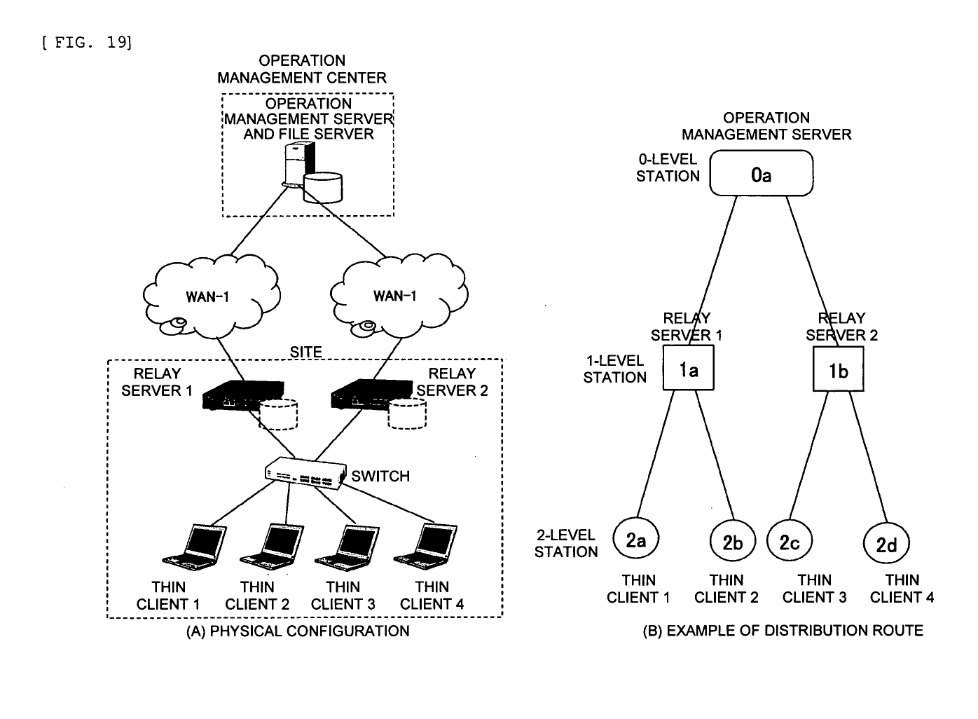

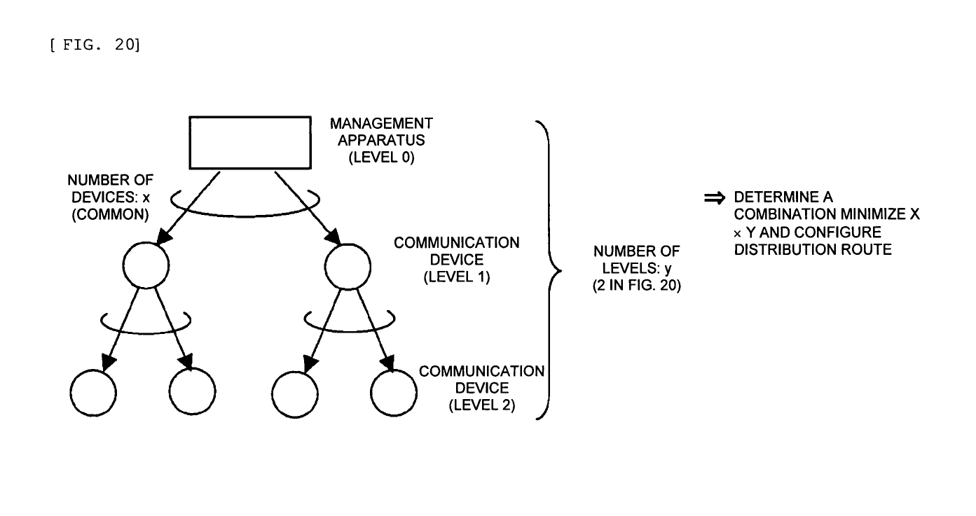

FIGS. 19A and 19B are block diagrams showing an exemplary configuration of the thin client system shown in FIG. 18. FIG. 19A is a block diagram showing a physical configuration of the thin client system and FIG. 19B is a block diagram showing an example of distribution routes.

The physical configuration of FIG. 19A shows physical devices and connection relationships among these physical devices. In the physical configuration shown in FIG. 19A, double WANs (WAN 1 and WAN 2) and double relay servers 1 and 2 are arranged and a plurality of routes (a route from WAN 1 to a relay server 1 and a route from WAN 2 to a relay server 2) are present as routes from the operation control server to respective thin clients.

For WAN, carrier services such as IP-VPN or wide-area Ethernet® provided by telecommunication carriers may be used. FIG. 19A shows that both the two WANs 1 and 2 are used as active networks (double WANs are used). Furthermore, in a site, all relay servers 1 and 2 and all thin clients 1 to 4 can be accommodated in one switch.

The example of the distribution routes shown in FIG. 19B corresponds to an example of configuring logical route so as to distribute data for thin clients from the operation control server to the respective thin clients in relation to FIG. 19A. The inter-device logical route is determined by assigning a device to which each device is to distribute next in the application level. By changing this assignment, the inter-device logical route can be changed.

As stated so far in detail, according to the embodiments of the present invention, even if an unexpectedly delay path is present or a failure occurs halfway along the distribution, communication does not slow down. If the processing performed by the station that holds the data is slow, the communication delay cannot be handled only by simply switching routes (because only the outputting path is changed) (as disclosed in, for example, Japanese Patent Application Laid-Open No. 2006-279810). According to the embodiments, by contrast, the above-stated advantages can be exhibited by switching over “(source station)+path”. Further, it is possible to handle a situation in which a certain device or path changes (e.g., a congestion or a failure occurs) during distribution. It is thereby possible to minimize the total distribution time and enable the control apparatus to grasp the distribution statues (whether distribution succeed or not) for all the devices. Besides, it is possible to take avoiding measures (e.g., distribution of the information through another route).

It is to be noted that a recording medium storing an information distribution program according to the present invention can be provided by providing a recording medium storing programs for causing a computer to execute the respective operations shown in the flowcharts or steps described with reference to the relevant drawings. The recording medium storing these programs can be recorded in a computer readable medium and executed by a computer. Examples of the computer readable medium include portable memory mediums such as a CD-ROM, a flexible disk, a DVD disk, a magneto optical disk, and an IC card, and databases holding a recording medium storing computer programs as well as other computers, databases of the other computers, and online transmission mediums.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A recording medium storing an information distribution program, the recording medium causing a computer transmitting information to a plurality of communication devices connected to a network to perform processing of:
(a) creating a distribution route including a plurality of levels by assigning a plurality of following level stations (0-level to n-level stations) at a distribution route creating means;
(b) distributing information using the distribution route created by the distribution route creating means at a distribution control means;
(c) monitoring a distribution status of the information distributed from one of communication devices as an m-level station in a lower level to one of the communication devices as an (m+1)-level station in a level lower than the lower level in which the m-level station is present at a distribution status monitoring means; and
(d) changing the distribution route created by the distribution route creating means, based on the distribution status monitored by the distribution status monitoring means, at a distribution route changing means.

2. The recording medium storing an information distribution program according to claim 1,
wherein the distribution route changing means changes a path, from a m-level station to a (m+1)-level station, to a path, from another m-level station in the same level with the m-level station to the (m+1)-level station, if it is determined that a communication speed of the m-level station is low based on the distribution status monitored by the distribution status monitoring means.

3. The recording medium storing an information distribution program according to claim 1,
wherein the distribution control means distributes information from the communication devices in a higher level to the communication devices in a lower level according to the distribution route created by the distribution route creating means,
the distribution status monitoring means sequentially monitors the distribution status, and
the distribution route changing means changes the distribution route, by incorporating a communication device for a predetermined level depending on the distribution status monitored by the distribution status monitoring means.

4. The recording medium storing an information distribution program according to claim 3,
wherein the distribution route changing means changes the distribution route created by the distribution route creating means by recursively performing a changing operation for a set of three levels from the m-level to (m+2)-level stations.

5. The recording medium storing an information distribution program according to claim 4,
wherein the distribution route changing means changes the distribution route by adding communication devices as an (m+1)-level station under each of a plurality of communication device as an m-level station based on distribution status of each of the plurality of communication devices as the m-level station monitored by the distribution status monitoring means.

6. The recording medium storing an information distribution program according to claim 1,
wherein, if the communication status monitoring means finds a communication device having a failure, the distribution control means redistributes information to the communication device having the failure.

7. The recording medium storing an information distribution program according to claim 5,
wherein, if the communication status monitoring means finds a communication device having a failure, the distribution control means instructs another communication device located in a level higher than the communication device having the failure by one and located in the same level as a communication device transmitting information to the communication device having the failure, is present, to redistribute information to the communication having the failure.

8. The recording medium storing an information distribution program according to claim 1,
wherein the distribution status monitoring means monitors distribution status of a plurality of stations under the distribution status monitoring means by detecting ACK and a timeout on an application layer.

9. An information distribution apparatus for distributing information by transmitting to a plurality of devices connected to a network comprising:
(a) a distribution route creating unit creating a distribution route including a plurality of levels by assigning a plurality of following level stations (0-level to n-level stations);
(b) a distribution control unit distributing information using the distribution route created by the distribution route creating unit;
(c) a distribution status monitoring unit monitoring a distribution status of the information distributed from one of communication devices as an m-level station in a lower level to one of the communication devices as an (m+1)-level station in a level lower than the level in which the m-level station is present; and
(d) a distribution route changing unit changing the distribution route created by the distribution route creating unit, based on the distribution status monitored by the distribution status monitoring unit.

10. The information distribution apparatus according to claim 9,
wherein the distribution route changing unit changes a path, from a m-level station to a (m+1)-level station, to a path, from another m-level station in the same level with the m-level station to the (m+1)-level station, if it is determined that a communication speed of the m-level station is low based on the distribution status monitored by the distribution status monitoring unit.

11. The information distribution apparatus according to claim 9,
wherein the distribution control unit distributes information from the communication devices in a higher level to the communication devices in a lower level according to the distribution route created by the distribution route creating unit,
the distribution status monitoring unit sequentially monitors the distribution status, and
the distribution route changing unit changes the distribution route, by incorporating a communication device for a predetermined level depending on the distribution status monitored by the distribution status monitoring unit.

12. The information distribution apparatus according to claim 11,
wherein the distribution route changing unit changes the distribution route created by the distribution route creating unit by recursively performing a changing operation for a set of three levels from the m-level to (m+2)-level stations.

13. The information distribution apparatus according to claim 12,
wherein the distribution route changing unit changes the distribution route by adding communication devices as an (m+1)-level station under each of a plurality of communication device as an m-level station based on distribution status of the plurality of communication devices as the m-level station monitored by the distribution status monitoring unit.

14. The information distribution apparatus according to claim 9,
wherein, if the communication status monitoring unit finds a communication device having a failure, the distribution control unit redistributes information to the communication device having the failure.

15. The information distribution apparatus according to claim 13,
wherein, if the communication status monitoring unit finds a communication device having a failure, the distribution control unit instructs another communication device located in a level higher than the communication device having the failure by one and located in the same level as a communication device transmitting information to the communication device having the failure, is present, to redistribute information to the communication having the failure.

16. The information distribution apparatus according to claim 9,
wherein the distribution status monitoring unit monitors distribution status of a plurality of stations under the distribution status monitoring unit by detecting ACK and a timeout on an application layer.

17. A method of causing a computer transmitting information to a plurality of communication devices connected to a network to perform processing of:
(a) creating a distribution route including plurality of levels by assigning a plurality of following level stations (O-level to n-level stations) at a distribution route creating means;
(b) distributing information using the distribution route created by the distribution route creating means at a distribution control means;
(c) monitoring a distribution status of the information distributed from one of communication devices as an m-level station in a lower level to one of the communication devices as an (m+1)-level station in a level lower than the lower level in which the m-level station is present at a distribution status monitoring mean; and
(d) changing the distribution route created by the distribution route creating means, based on the distribution status monitored by the distribution status monitoring means, at a distribution route changing means.

18. The method of causing the computer to distribute information according to claim 17,
wherein the distribution route changing means changes a path, from a m-level station to a (m+1)-level station, to a path, from another m-level station in the same level with the m-level station to the (m+1)-level station, if it is determined that a communication speed of the m-level station is low based on the distribution status monitored in the distribution status monitoring step.

19. The method of causing the computer to distribute information according to claim 17,
wherein the distribution control means distributes information from the communication devices in a higher level to the communication devices in a lower level according to the distribution route created by the distribution route creating means,
the distribution status monitoring means sequentially monitors the distribution status, and
the distribution route changing means changes the distribution route, by incorporating a communication device for a predetermined level depending on the distribution status monitored in the distribution status monitoring step.

20. The method of causing the computer to distribute information according to claim 19,
wherein the distribution route changing means changes the distribution route created by the distribution route creating means by recursively performing a changing operation for a set of three levels from the m-level to (m+2)-level stations.

21. A method of distributing information to a plurality of communication devices connected to a network, comprising:
creating a distribution route including a plurality of levels by assigning a plurality of following level stations (0-level to n-level stations) to the distribution route;
distributing information from one of the communication devices as an m-level station in a lower level to one of the communication devices as an (m+1)-level station in a level lower than the lower level in which the m-level station is present using the distribution route;
monitoring a distribution status of the information distributed; and
changing the distribution route based on the distribution status.

22. An apparatus for distributing information to a plurality of devices connected to a network, comprising:
a distribution route including a plurality of levels, a plurality of following level stations (0-level to n-level stations) assigned to the distribution route;
a distribution controller distributing information from one of communication devices as an m-level station in a lower level to one of the communication devices as an (m+1)-level station in a level lower than the level at which the m-level station is present using the distribution route;
a distribution status monitor monitoring a distribution status of the distributed information; and
a distribution route changer changing the distribution route based on the distribution status monitored by the distribution status monitor.

23. A system for distributing information to a plurality of communication devices connected to a network, comprising:
means for creating a distribution route including a plurality of levels by assigning a plurality of following level stations (0-level to n-level stations) to the distribution route;
means for distributing information from one of the communication devices as an m-level station in a lower level to one of the communication devices as an (m+1)-level station in a level lower than the lower level in which the m-level station is present using the distribution route;
means for monitoring a distribution status of the information distributed; and
means for changing the distribution route based on the distribution status.
